(19) United States
(12) Patent Application Publication
(10) Pub. No.: US 2025/0092215 A1
(43) Pub. Date: Mar. 20, 2025

(54) PLASTIC DEPOLYMERIZATION USING SILICA BASED CATALYSTS

(71) Applicant: Basell Poliolefine Italia S.r.l., Milano (IT)

(72) Inventors: Diego Brita, Ferrara (IT); Simona Guidotti, Ferrara (IT); Dario Liguori, Ferrara (IT); Francesco Menichelli, Ferrara (IT)

(73) Assignee: Basell Poliolefine Italia S.r.l., Milano (IT)

(21) Appl. No.: 18/293,298

(22) PCT Filed: Jul. 13, 2022
(86) PCT No.: PCT/EP2022/069545

§ 371 Date: Jan. 29, 2024

(30) Foreign Application Priority Data
Aug. 3, 2021 (EP) 21189247.6

(51) Int. Cl. C08J 11/16; B01J 21/06; B01J 21/08; B01J 23/14; B01J 23/18; B01J 35/61; B01J 35/63; B01J 35/64

(52) U.S. Cl. CPC C08J 11/16; B01J 21/063; B01J 21/08; B01J 23/14; B01J 23/18; B01J 35/613; B01J 35/615; B01J 35/617; B01J 35/633; B01J 35/635; B01J 35/643; B01J 35/647; B01J 35/651; C08J 2323/12

(57) ABSTRACT

A process for depolymerizing plastics of a plastic waste feedback, using a doped silica catalyst.

### FIELD OF THE DISCLOSURE

In general, the present disclosure relates to the field of chemistry. More specifically, the present disclosure relates to polymer chemistry. In particular, the present relates to a method for depolymerizing plastic feedstock.

### BACKGROUND OF THE DISCLOSURE

For some applications, plastics are inexpensive and durable materials for manufacturing a variety of products. As such, the production of plastics has increased dramatically over the last decades. In some instances, the durability of the plastics contributes to an increase in the amount of plastics in landfill sites and natural habitats. In some instances, degradable and biodegradable plastics persist depending on environmental factors, such as ultraviolet light exposure, temperature, and the presence of microorganisms.

Currently, plastic recycling primarily includes mechanical recycling and chemical recycling. With mechanical recycling, plastics are transformed without changing their chemical structure and may be used to produce new materials. In some instances, mechanical recycling steps include: collecting plastic wastes; sorting plastic wastes by type and color; pressing or milling plastics for packaging plastics; washing and drying plastics; and reprocessing plastics into pellets by agglutinating, extruding, and cooling the plastics. In some instances, the plastics are polyolefins such as polyethylene (PE) and polypropylene (PP).

Alternatively, chemical recycling modifies the structure of plastics, thereby permitting use of the resulting plastics as raw material for different industries or as a basic input or feedstock for manufacturing new plastic products. In some instances, chemical recycling steps include: collecting plastics and heating the plastics to a temperature at which the polymers break down into fragments. In some instances, this process is referred to as depolymerization and converts the plastic waste material to liquid fuel by thermal degradation (cracking) in the absence of oxygen. In some instances, plastic waste is first melted within a stainless steel chamber, under an inert purging gas. Next, the molten material is heated to a gaseous state. Then, the gaseous material is drawn and condensed in one or more condensers, thereby yielding a hydrocarbon distillate made from or containing straight and branched chain aliphatic, cyclic aliphatic, and aromatic hydrocarbons. In some instances, the resulting mixture is used as a fuel. In some instances, the resulting mixture is used as a feedstock in a thermocatalytic process for obtaining refined chemicals such as monomers.

### SUMMARY OF THE DISCLOSURE

In a general embodiment, the present disclosure provides a process for depolymerizing plastics, including the steps of:
a) providing a plastic waste feedstock;
b) mixing the plastic waste feedstock with a catalyst, thereby obtaining a reactant mixture; and
c) heating the reactant mixture to a temperature ranging from 280° C. to 600° C., thereby obtaining a depolymerization product;
   wherein the catalyst is a silica based material, having a porosity (BET method) ranging from 0.2 to 1.0 cm³/g, a surface area ranging from 100 to 500 m²/g, and an average pore radius ranging from 0.5 to 50 nm, and being doped with a metal or metalloid selected from the groups consisting of 3-15 of the Periodic Table of Elements (IUPAC Version) with the exclusion of Fe and Mo.

In some embodiments, the reactant mixture is made from or containing 1-20 wt. %, alternatively 1-10 wt. %, alternatively from 1 to 5 wt. %, of the catalyst, with respect to the weight of the total reactant mixture.

In some embodiments, the plastic waste feedstock is made from or containing a polyolefin or a mixture of polyolefins. In some embodiments, a polyolefin mixture is used as the plastic waste feedstock and is made from or containing a mixture of polyethylene and polypropylene. In some embodiments, the polyethylene is selected from the group consisting of high density polyethylene (HDPE), low-density polyethylene (LDPE), and linear low density polyethylene (LLDPE). In some embodiments, the polypropylene (PP) is a propylene homopolymer or a propylene copolymer, having a lower amount of ethylene, butene, or both. In some embodiments, the feedstock is made from or containing other polyolefins like polybutene. In some embodiments, the feedstock is further made from or containing other polymeric materials. In some embodiments, the other polymeric materials are selected from the group consisting of polystyrene (PS), ethyl-vinyl acetate copolymer (EVA), ethyl-vinyl alcohol copolymer (EVOH), polyvinyl chloride (PVC), and mixtures thereof. In some embodiments, the feedstock is made from or containing more than 80 wt % of polypropylene. In some embodiments, the feedstock is made from or containing a mixture of polyethylene and polypropylene, wherein polypropylene accounts for more than 50 wt % of the polypropylene/polyethylene mixture.

In some embodiments, the depolymerization process occurs in an oxygen-free environment. In some embodiments, an oxygen containing atmosphere is not introduced into the depolymerization system. In some embodiments, a barrier to the potentially oxygen-containing atmosphere is obtained with a series of expedients. In some embodiments, the series of expedients is selected from the group consisting of nitrogen blanketing and a vacuum system connected to a barrel of the extruder.

In some embodiments, the plastic feedstock mixture is charged into the feeding system of the depolymerization reactor by a hopper, or two or more hoppers in parallel. In some embodiments, the oxygen present in the atmosphere of the plastic waste material is eliminated inside the hopper(s).

In some embodiments, the plastic feedstock is fed directly into the depolymerization reactor for small scale tests. In some embodiments and for larger scale, the plastic feedstock is fed to the depolymerization reactor by an extruder.

In some embodiments, the plastic scrap is melted and then injected into the depolymerization reactor. In some embodiments, the extruder receives the plastic scrap cut in small pieces into the feed hopper, conveys the stream in the melting section, and heats the polymer by combined action of mixing energy and heat supplied by barrel heaters. In some embodiments, the melting temperature ranges from 250 to 350° C.

In some embodiments, additives are incorporated in the melt. In some embodiments, the additives reduce corrosivity of plastic scrap or improve depolymerization efficiency.

In some embodiments and during the extrusion, one or more degassing steps remove residual humidity present in the product.

In some embodiments and before being fed to the reactor, the melt stream cis filtered, thereby removing solid impurities from the plastic waste.

In some embodiments, the extrusion systems are selected from the group consisting of single screw extruders, twin screw extruders, twin screw extruders with gear pump, and combination thereof.

In some embodiments, mixing of the plastic waste feedstock and catalyst takes place directly into the depolymerization reactor or beforehand, outside the reactor. In some embodiments, the mixing takes place in the depolymerization reactor, wherein the catalyst is fed (a) by pouring directly the solid catalyst into the reactor under a nitrogen atmosphere or (b) in a form of a liquid hydrocarbon slurry or a semisolid paste using dedicated devices.

In some embodiments, the mixing takes place outside the depolymerization reactor, wherein the catalyst is mixed with plastic scrap in a homogenizer apparatus and the mixture is then pelletized. In some embodiments, the pellets are further made from or containing other additives. In some embodiments, the pellets are charged to the extruder hopper, which is used to feed the polymerization reactor. In some embodiments, the plastic scrap and catalysts are charged separately into the hopper. In some embodiments, the mixing takes place into the extruder at the time of plastic scrap melting and the mixture is subsequently fed to the depolymerization reactor.

In some embodiments, the depolymerization reactor is an agitated vessel, operated at temperature ranging from 300 to 550° C., alternatively from 350 to 500° C., alternatively from 350 to 450° C., with an inlet for plastic feedstock and catalyst and an outlet for the gaseous depolymerization product.

In some embodiments and as a result of the depolymerization process, a gaseous stream is generated and sent to a condensation unit, which totally or partially liquifies the stream.

In some embodiments, the condensation section receives effluent gases from the depolymerization reactor and partially condenses the gases into an oily product made from or containing hydrocarbons. In some embodiments, a fraction of incondensable gases is collected and stored separately. In some embodiments, the condensation section has one or more stages. In some embodiments, the stages are operated under pressure or not. In some embodiments, the stages are operated at different temperatures. In some embodiments, the operating conditions of the number of stages, pressure, or temperature permit recovery of the maximum amount of products, according to the volatility of the resulting formed compounds. In some embodiments, the temperature range varies depending on the operating pressure.

In some embodiments, the condensation section has at least two condensation stages, operating at descending temperatures. In some embodiments and with small scale equipment, the first condensation stage is operated at a temperature range of 100-120° C. and the second at a temperature range of from 2° C. to −20° C.

In some embodiments and at the end of the process, at least 80% wt., alternatively 90% wt., of the plastic waste feedstock is converted into a liquid or gaseous depolymerization product.

In some embodiments, the depolymerization product is used as a cracker feedstock. In some embodiments, the depolymerization product is a liquid depolymerization product. In some embodiments, the amount of liquid depolymerization product is higher than 65% wt., alternatively higher than 70% wt., alternatively from 70 to 90% wt., of the plastic waste feedstock.

In some embodiments, the liquid depolymerization product is made from or containing a very low amount of fractions with C28 or higher. In some embodiments, the liquid depolymerization product is free of fractions with C28 or higher. In some embodiments, the liquid depolymerization product is made from or containing an amount of the higher than C28 fraction equal to, or lower than, 4 wt %, alternatively lower than 3 wt %, alternatively lower than 2 wt %, with respect to the total amount of liquid depolymerization product.

In some embodiments, the amount of the aromatic fraction in the liquid depolymerization product is equal to or lower than 0.10% wt, alternatively lower than 0.07% wt, alternatively lower than 0.05% wt, with respect to the total amount of liquid depolymerization product.

In some embodiments, the quality of the liquid depolymerization product as a cracker feedstock is determined by the Branch Index. As used herein, the term “Branch Index” is defined as the molar ratio between internal double bonds with respect to double bond in chain end position (alpha-olefins). In some embodiments, the liquid depolymerization product has a Branch Index lower than 0.15, alternatively lower than 0.14, alternatively lower than 0.12.

As used herein, the term “C6-C8 aromatics” refer to a hydrocarbon with sigma bonds and delocalized pi electrons between carbon atoms forming a circle, wherein total of 6 to 8 carbon atoms are present.

In some embodiments and in the catalyst, the silica based material is doped with metals or metalloids selected from the group consisting of Ti, Sn, Bi, Al, Mn, W, and mixtures thereof. In some embodiments, the doping metal is selected from the group consisting of Ti, Sn, Bi, and mixtures thereof. In some embodiments, the doping metal is selected from the group consisting of Ti, Sn, and Bi.

In some embodiments, the silica based material of the catalyst has a porosity ranging from 0.20 to 0.50 cm³/g, a surface area ranging from 100 to 300 m²/g, and an average pore radius ranging from 0.5 to 20 nm, alternatively from 0.5 to 15 nm, alternatively from 1 to 10 nm.

In some embodiments, the mesoporous silica material is synthesized by silicate polycondensation in a citric acid/citrate solution of Pluronic F127 [Chem. Mater. 2015, 27, 5161-5169]. In some embodiments, the mesoporous silica material is synthesized in a one-step aqueous process, wherein the metals doped silica is prepared using induced self-assembly of tetraethoxy silane, a metal salt, and a triblock copolymer template [Studies in Surface Science and Catalysis, 2006, 162, 369-376].

### CHARACTERIZATION

The properties are determined according to the following methods.

### Porosity and Surface Area with Nitrogen

Measures of porosity were carried out according to the B.E.T. method (apparatus used Sorptomatic 1900 by Carlo Erba). The samples analyzed were preheated at 350° C. for 7 h under high vacuum. Data collection and elaboration were made using the Sorptomatic software associated to the instrument.

### Analytical Methods

The GC analysis of the liquid product was performed using an Agilent 7890 GC (Agilent Technologies, Santa Clara, CA), equipped with a non-polar column and a flame ionization detector. The following fractions were collected: S-RT=x<nC7, M-RT=nC7<x<nC11; L-RT=nC12<x<nC28, XL-RT=x>C28

The relative amount of the last three fractions is reported in Table 1.

NMR data was used to characterize the percent of aromatic protons, paraffinic protons, and olefinic protons in the liquid product. Examples were analyzed with an addition of CDCl₃ (0.6 g of depolymerize polymer/metal oxide mixture with 0.4 g of CDCl₃). The data was collected on a Bruker AV500 MHz NMR spectrometer (Bruker Corporation, Billerica, MA) at 25° C. with a 5 mm Prodigy probe. One dimension ¹H NMR data was processed using TOPSPIN® software (Bruker) with an exponential line broadening window function. Quantitative measurements were performed with a 15 second relaxation delay, a 30° flip angle pulse, and 32 scans, thereby facilitating integrals. The spectral integrations for aromatic, olefinic, and paraffinic protons were obtained and used to quantify relative ratios.

### EXAMPLES

### Depolymerization Procedure

30 g of Moplen HP522H polypropylene were loaded in a 500 ml round glass reactor, having three necks equipped with thermocouple and nitrogen inlet. The solid catalyst (0.8 grams) was introduced into the glass reactor. Two glass condenser were connected in series and kept at 110° C. and −8° C., respectively, using an oil bath (Cryostat Julabo). The reactor was placed in electrical, heating system (mantle bath). The temperature was raised up to 420-430° C. After the pyrolysis process, the following experimental parameters were recorded:
Tₒₙₛₑₜ, temperature of reaction mixture, when condensation of liquid product first observed
L %, yield of liquid condensable in an ice trap (with respect to the polymer charged)
S %, yield of solid/waxy residue in the reactor, excluding catalyst (with respect to the polymer charged)
G %, yield of gaseous products that did not condense

### Comparative Example 1

A solution of 2.60 g of Pluronic F127 (BioVision, amphiphilic block copolymer) in 107.5 mL of deionized water was prepared at room temperature (r.t.) into a 500 mL round-bottom flask, equipped with a mechanical stirrer. To this solution, 3.68 g of citric acid monohydrate (Sigma-Aldrich, 17.53 mmol) and 2.54 g of sodium citrate dihydrate (MP Biomedicals, 8.64 mmol) were added. The resulting mixture was stirred at r.t. for a few h until complete dissolution. Subsequently, 10.4 g of sodium silicate solution (Sigma-Aldrich, ˜26.5% wt. SiO₂, d=1.39 g/mL) diluted in 30 mL of deionized water was added at r.t., under stirring, to the buffered F127 Pluronic solution. Immediately, a white solid precipitated. Stirring was continued for 30 min, then the suspension was kept at rest for 24 h at room temperature. The resulting material was filtered on a G4 frit, washed, and dried at 50° C. under vacuum. Finally, the powder was calcined in air at 350° C. for 24 h. The process yielded 2.9 g of a free flowing powder, showing, at the BET characterization, a surface area of 533 m²/g, a porosity of 0.327 g/cm³, and an average diameter of 12 nm. The catalyst was used in the depolymerization test. The results are reported in Table 1.

### Example 1: Sn Doped Catalyst

0.75 g of Pluronic F127 (BioVision, amphiphilic block copolymer) and 0.59 g of NaCl (Sigma-Aldrich) were dissolved at r.t. into 70 mL of deionized water. 2.10 g of tetraethyl orthosilicate (TEOS, Thermo Fisher Scientific) was added at 35° C., under stirring, into the solution. The resulting mixture was kept at 35° C. for 4 h. A milk colloidal solution was obtained. A freshly prepared 0.2 M solution of SnCl₄*5H₂O (Acros, 10 mL) was then added at 35° C. and stirring was kept at 35° C. for 24 h. Subsequently, the reaction mixture was transferred to a PP bottle and hydrothermally treated at 90° C. under static conditions for 6 h. The solid precipitates were recovered by filtering, washing, and drying at 100° C. overnight. Finally, the powder was calcined in air at 500° C. for 6 h. The process yielded 1.6 g of a free flowing powder. The catalyst was used in the depolymerization test. The results are reported in Table 1.

### Example 2: Ti Doped Catalyst

The preparation of the depolymerization catalyst was carried out following the procedure reported in Example 1, but using a 0.2 M solution of TiCl₄ (Sigma-Aldrich, 10 mL) as doped metal source. The process yielded 1.2 g of a free flowing powder. The catalyst was used in the depolymerization test. The results are reported in Table 1.

### Example 3: Bi Doped Catalyst

The preparation of the depolymerization catalyst was carried out following the procedure reported in Example 1, but using a 0.2 M solution of BiCl₃ (Sigma-Aldrich) as doped metal source. The reaction was carried out starting from 2.25 g of Pluronic F127. The process yielded 3.0 g of a free flowing powder, showing, at the BET characterization, a surface area of 267 m²/g, a porosity of 0.229 g/cm³, and an average diameter of 17 nm. The catalyst was used in the depolymerization test. The results are reported in Table 1.

### Comparative Example 2: Fe Doped Catalyst

The preparation of the depolymerization catalyst was carried out following the procedure reported in Example 1, but using a 0.2 M solution of FeCl₃ (Sigma-Aldrich) as doped metal source. The reaction was carried out starting from 2.25 g of Pluronic F127. The process yielded 2.2 g of a free flowing powder, showing, at the BET characterization, a surface area of 325 m²/g, a porosity of 0.577 g/cm³, and an average diameter of 35 nm. The catalyst was used in the depolymerization test. The results are reported in Table 1.

TABLE 1

| | Solid | Liquid | Gas | C12-C22 | C22-C28 | >C28 | Aromatics | |
|---|---|---|---|---|---|---|---|---|
| Ex. | (% wt) | (% wt) | (% wt) | (% wt) | (% wt) | (% wt) | (%) | BI |
| C1 | 1.0 | 83 | 16 | 46 | 6 | 1.2 | 0.08 | 0.21 |
| 1 | 0.0 | 86 | 14 | 43 | 2 | 0.0 | 0.07 | 0.10 |
| 2 | 9.0 | 72 | 19 | 43 | 0 | 0.0 | 0.04 | 0.09 |
| 3 | 6.0 | 80 | 14 | 44 | 6 | 3.0 | 0.04 | 0.11 |
| C2 | 4.0 | 81 | 15 | 44 | 3 | 1.0 | 0.12 | 0.17 |

1. A process for depolymerizing plastics, comprising the steps of:
a) providing a plastic waste feedstock;
b) mixing the plastic waste feedstock with a catalyst, thereby obtaining a reactant mixture; and
c) heating the reactant mixture to a temperature ranging from 280° C. to 600° C., thereby obtaining a depolymerization product;
wherein the catalyst is a silica based material, having a porosity (BET method) ranging from 0.2 to 1.0 cm³/g, a surface area ranging from 100 to 500 m²/g, and an average pore radius ranging from 0.5 to 50 nm, and being doped with a metal or metalloid selected from the groups 3-15 of the Periodic Table of Elements (IUPAC Version) with the exclusion of Fe and Mo.

2. The process of claim 1, wherein the silica based material is doped with metals or metalloids selected from the group consisting of Ti, Sn, Bi, Al, Mn, W, and mixtures thereof.

3. The process of claim 2, wherein the silica based material is doped with metals or metalloids selected from the group consisting of Ti, Sn, Bi, and mixtures thereof.

4. The process of claim 1, wherein the silica based material has a porosity ranging from 0.20 to 0.50 cm³/g.

5. The process of claim 1, wherein the silica based material has a surface area ranging from 100 to 300 m²/g.

6. The process of claim 1, wherein the silica based material has an average pore radius ranging from 0.5 to 20 nm.

7. The process of claim 6, wherein the silica based material has an average pore radius ranging from 0.5 to 15 nm.

8. The process of claim 1, wherein the reactant mixture comprises 1-20 wt % of the catalyst, with respect to the weight of the total reactant mixture.

9. The process of claim 1, wherein the plastic waste feedstock comprises a polyolefin or a mixture of polyolefins.

10. The process of claim 9, wherein the plastic waste feedstock comprises a mixture of polyethylene and polypropylene.

11. The process of claim 1, wherein at least 90% of the plastic waste feedstock is converted into a liquid or gaseous depolymerization product.

12. The process of claim 11, wherein the amount of liquid depolymerization product is higher than 65% wt. of the initially fed plastic waste feedstock.

13. The process of claim 1, wherein the liquid depolymerization product has a fraction higher than C28 in an amount equal to, or lower than, 4%, with respect to the total amount of liquid depolymerization product.

14. The process of claim 1, wherein the liquid depolymerization product has an aromatic fraction in an amount equal to, or lower than, 0.10%, with respect to the total amount of liquid depolymerization product.

15. The process of claim 1, wherein the liquid depolymerization product has a Branch Index lower than 0.15.
